(19) United States
(12) Patent Application Publication
(10) Pub. No.: US 2014/0219702 A1
(43) Pub. Date: Aug. 7, 2014

(54) Pen/Pencil Grip

(71) Applicant: Custom Device Technologies, LLC, Warren, NJ (US)

(72) Inventors: Allan D. Pincus, Green Brook, NJ (US); Walter D. Barger, III, Cherry Hill, NJ (US); Bonnie Mauer, Morristown, NJ (US)

(73) Assignee: Custom Device Technologies, LLC, Warren, NJ (US)

(21) Appl. No.: 14/165,937

(22) Filed: Jan. 28, 2014

Related U.S. Application Data
(63) Continuation of application No. 29/444,524, filed on Jan. 31, 2013.
(60) Provisional application No. 61/817,425, filed on Apr. 30, 2013.

(51) Int. Cl. B43K 23/008

(52) U.S. Cl. CPC B43K 23/008
USPC 401/6

(57) ABSTRACT

The present disclose describes and teaches a pen/pencil grip and a product combining the pen/pencil grip with a pen/pencil. The pen/pencil grip may include a head section, a middle section, and a tail section forming a continuous and smoothly connected body. Positioned on the pen/pencil grip are placement recesses and grooves to accommodate the thumb, index finger, middle finger, ring finger, little finger, and thenar eminence of a human hand. The pen/pencil grip may also include a channel that may receive the shaft of a pen/pencil. A final product may include the pen/pencil and the grip, forming a writing apparatus that is easy to use, prevents writing fatigue, and helps to establish good writing habits and healthy posture.

### CLAIM OF PRIORITY

This application is a continuation application of U.S. application Ser. No. 29/444,524 filed on Jan. 31, 2013. This application also claims priority to U.S. Application 61/817,425 filed on Apr. 30, 2013, the contents of both said applications being incorporated by reference in their entirety.

### FIELD OF THE INVENTION

The current invention relates to an accessory device that prevents writing fatigues and helps people, especially children, to hold a pen or pencil correctly while writing. In particular, the current invention relates to a pen/pencil grip that may be attached to a pen or pencil, enabling the user to grip the pen/pencil in a correct manner. In addition, the current invention also covers embodiments that include not only the grip, but also the pen/pencil being used.

### BACKGROUND OF THE INVENTION

Even in an age of computers and printers, writing with a pen or pencil has persisted as an essential part of many people's lives. In many cases, users grip pens and pencils directly by the shafts to write. However, it is easy to get tired and uncomfortable at his/her finger tips and other points held flush against the shaft. Moreover, when children are learning to write, it is important to teach them how to grip the pen/pencil in a proper manner and maintain a healthy posture. Thus, it is desirable to provide accessory devices that offer guidance to people regarding the best way to hold a pen/pencil. Some devices have been developed for such purposes.

### DESCRIPTION OF RELATED ART

U.S. Pat. No. 7,014,379 discloses a pen holding auxiliary device that not only provides comfortable touches but also the distance between the sleeves is adjustable to fit users' hands of different sizes. The device mainly comprises a front sleeve, a back sleeve and a length adjustable element. The front sleeve slidably embraces a shaft of the pen for being placed between finger tips. The back sleeve slidably embraces the shaft of the pen for being placed against a part of the hand between a thumb and an index finger thereof. The length adjustable element surrounds the shaft of the pen and connects the front sleeve with one end and connects the back sleeve with the other end.

U.S. Pat. No. 8,152,396 discloses a writing instrument grip apparatus for holding a writing instrument for performing writing, the apparatus includes a first member adapted to receive a user's thumb and index and side of middle fingers and having a substantially vertical cylindrical chamber for receiving the writing instrument adapted to extend past a bottom surface of the first member for contacting a surface for performing writing; and a second member adapted to receive a user's middle, ring, and small fingers coupled to a top of the first member so that motion of the hand of the user powers the writing instrument for performing the writing in response to the motion; wherein pressure is directed away from joints of the thumb and at least one finger of the hand of the user.

These disclosures, however, are not as complete and easy to use as the current invention, which provides finger placement positions, as well as additional grooves and bulges that compliment other parts of a hand. The current invention is a more advantageous solution compared with the other teachings.

In summary, various devices are known in the art, but they are distinctively different from the current invention. Moreover, the other inventions fail to address the issues solved by the invention described herein. One embodiment of this invention is illustrated in the accompanying drawings and will be described in more detail herein below.

### SUMMARY OF THE INVENTION

The current invention discloses a pen/pencil grip, comprising: a head section having a head section frontal end flanged by a thumb placement recess, an index finger placement recess, and a middle finger placement frontal facet; a middle section connected to the head section opposite to the head section front end, the middle section having a lower bulge with a middle finger placement back facet positioned adjacent to the middle finger placement frontal facet; and a tail section connected to the middle section opposite to the head section, wherein the head section, the middle section, and the tail section form a continuous and smoothly connected body, the thumb placement recess has a shallow alcove contour configured to receive a distal phalanx of a human thumb, the index finger placement recess has a shallow alcove contour configured to receive a distal phalanx of a human index finger, the middle finger placement front facet and the middle finger placement back facet combines to form a middle finger placement groove configured to allow the placement of a distal phalanx of a human middle finger, the tail section is an elongated structure extended from the middle section, the tail section includes a ring finger placement recess configured to receive the distal phalanx of a human ring finger, the tail section includes a little finger placement recess configured to receive the distal phalanx of a human little finger, there is a pen/pencil shaft placement channel extending from the head section frontal end through the head section and middle section, and the pen/pencil shaft placement channel is configured to accommodate a shaft of a pen/pencil.

Here the term pen/pencil is meant to cover all kinds of writing implements having a tip and shaft, wherein the writing implement can be used to leave marks, such as words or drawings, on paper or other surfaces. The current invention covers not only the grip, but also a writing apparatus that incorporates the grip and the pen/pencil.

To make the pen/pencil more user friendly, the thumb placement recess, the index finger placement recess, and the middle finger recess may be decorated with drawings.

To better accommodate other hand structures, the middle section may include a side bulge corresponding to a position between the thumb and the index finger. In addition, between the tail section and the middle section there may be a thenar placement groove configured to receive the thenar eminence of a human hand.

To ensure full functionality, the current invention may have embodiments that are suitable to either the right hand or the left hand. When the pen/pencil grip is suitable for a right hand, a series of implements are necessary, including: the side bulge is on the right of the middle section viewed from the middle finger placement back facet and thenar placement groove is on the right of the middle section viewed from the middle finger placement back facet. The left hand implement may be a minor image of the right hand implement. On the alternative, the left hand implement and the right hand implement may have small differences reflecting people's specific needs and general habits when they write right-handed or left-handed.

The current invention may also incorporate accessory structures to improve the results for better gripping postures. For example, the pen/pencil grip may include indicators such as LED lights or buzzers. There may also be electrical switches underneath the finger locations so that correctly positioned fingers may trigger or alter the display of the indicators, serving as a sign of correct or incorrect gripping.

In general, the present invention succeeds in conferring at least the following desirable and useful benefits and objectives:

It is an object of the present invention to provide a pen/pencil grip that includes placement positions for all the fingers.

It is an object of the present invention to provide a pen/pencil grip that can be both useful and entertaining.

It is an object of the present invention to provide a pen/pencil grip that forms a continuous and smoothly connected body.

It is an object of the present invention to provide a pen/pencil grip that is strong and robust.

It is another object of the current invention to provide a pen/pencil grip that includes embodiments for either the left hand or the right hand.

It is another object of the current invention to provide a pen/pencil grip that may accommodate all kinds of writing implements.

It is still another object of the current invention to provide a pen/pencil grip that is portable and easy to carry around.

It is another object of the current invention to provide a pen/pencil grip that is inexpensive.

It is another object of the current invention to provide a pen/pencil grip that is easy to manufacture.

It is yet another object of the current invention to provide a writing apparatus that incorporates the pen/pencil grip.

It is yet another object of the current invention to provide a writing apparatus that incorporates a pen/pencil.

It is yet another object of the current invention to provide a writing apparatus that that reduces writing fatigue and helps children to develop correct writing postures.

### BRIEF DESCRIPTION OF THE DRAWINGS

FIG. 1 shows a front view of a preferred embodiment of the current invention.

FIG. 2 shows a back view of a preferred embodiment of the current invention.

FIG. 3 shows a first side view of a preferred embodiment of the current invention.

FIG. 4 shows a second side view of a preferred embodiment of the current invention.

FIG. 5 shows a top view of a preferred embodiment of the current invention.

FIG. 6 shows a bottom view of a preferred embodiment of the current invention.

FIG. 7 shows a bottom side perspective view of a preferred embodiment of the current invention.

FIG. 8 shows a side perspective view of a preferred embodiment of the current invention wherein the embodiment is use—held by a hand.

### Description of the Preferred Embodiments

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

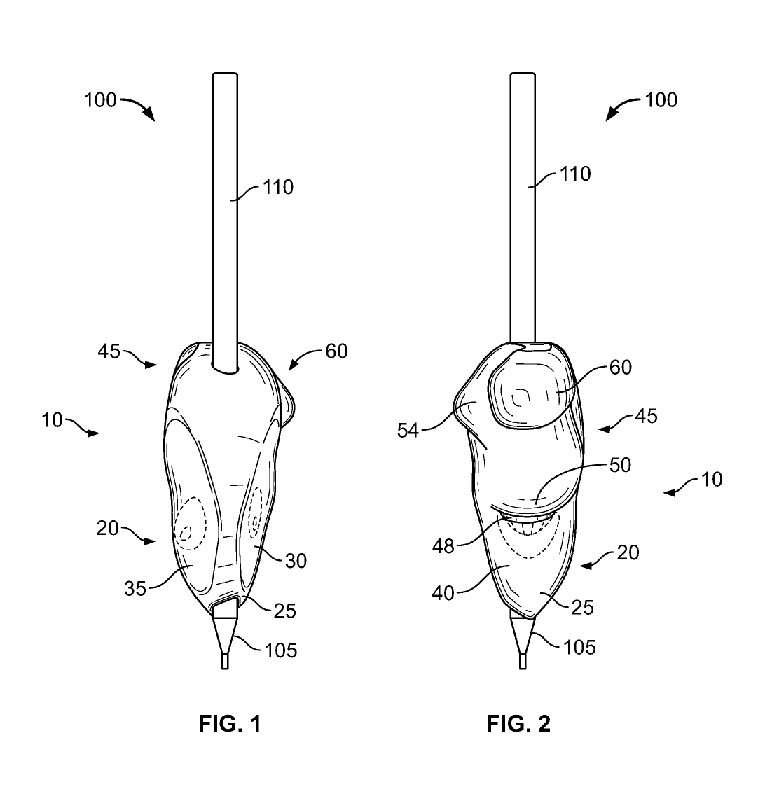

FIG. 1 shows a front view of a preferred embodiment of the current invention. Shown in FIG. 1 is a writing implement including a pen/pencil grip 10 and a pen/pencil 100, wherein the pen/pencil grip 10 comprises a head section 20, a middle section 45, and a tail section 60, and the pen/pencil 100 includes a tip 105 and a shaft 110. The head section 20 includes a head section frontal end 25, a thumb placement recess 30, and an index finger placement recess 35. A shaft placement channel extends through the head section 20 and the middle section 45 with existing holes on the top of the middle section 45 and the head section frontal end 25. The shaft 110 of the pen/pencil 100 is securely accommodated by the shaft placement channel, wherein the tip 105 extends out of the hole on the head section frontal end 25.

FIG. 2 shows a back view of a preferred embodiment of the current invention. Shown in FIG. 2 is a writing implement including a pen/pencil grip 10 and a pen/pencil 100, wherein the pen/pencil grip 10 comprises a head section 20, a middle section 45, and a tail section 60, and the pen/pencil 100 includes a tip 105 and a shaft 110. The head section 20 includes a head section frontal end 25 and a middle finger placement frontal facet 40. A shaft placement channel extends through the head section 20 and the middle section 45 with the shaft 110 of the pen/pencil 100 being securely accommodated by the shaft placement channel, wherein the tip 105 extends out of the hole on the head section frontal end 25. The middle section 45 of the pen/pencil grip 10 includes a lower bulge 50 and a side bulge 54, wherein the lower bulge 50 includes a middle finger placement back facet 48 positioned adjacent to the middle finger placement frontal facet 40, so that the middle finger placement back facet 48 and the middle finger placement frontal facet 40 may be combined to form a middle finger placement groove.

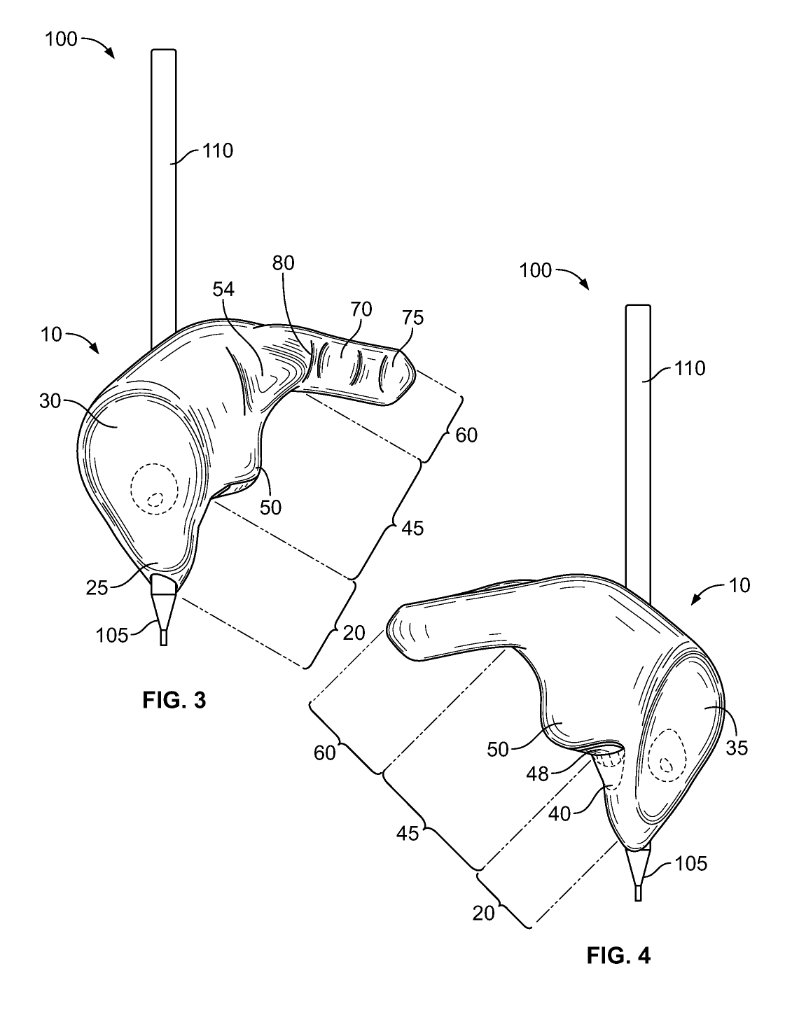

FIG. 3 shows a first side view of a preferred embodiment of the current invention. Shown in FIG. 3 is a writing implement including a pen/pencil grip 10 and a pen/pencil 100, wherein the pen/pencil grip 10 comprises a head section 20, a middle section 45, and a tail section 60, and the pen/pencil 100 includes a tip 105 and a shaft 110. The three sections of the pen/pencil grip are best illustrated in FIGS. 3 and 4. The head section 20 includes a head section frontal end 25 and a thumb placement recess 30. The middle section 45 of the pen/pencil grip 10 includes a lower bulge 50 and a side bulge 54, wherein the lower bulge 50 includes a middle finger placement back facet 48 positioned adjacent to the middle finger placement frontal facet 40 of the head section 20, so that the middle finger placement back facet 48 and the middle finger placement frontal facet 40 may be combined to form a middle finger placement groove. The tail section 60 includes a ring finger groove 70 and a little finger groove 75. Between the middle section 45 and tail section 60 is a thenar placement groove 80.

FIG. 4 shows a second side view of a preferred embodiment of the current invention. Shown in FIG. 4 is a writing implement including a pen/pencil grip 10 and a pen/pencil 100, wherein the pen/pencil grip 10 comprises a head section 20, a middle section 45, and a tail section 60, and the pen/pencil 100 includes a tip 105 and a shaft 110. The head section 20 includes a head section frontal end 25 and an index finger placement recess 35. The middle section 45 of the pen/pencil grip 10 includes a lower bulge 50, wherein the lower bulge 50 includes a middle finger placement back facet 48 positioned adjacent to the middle finger placement frontal facet 40 of the head section 20, so that the middle finger placement back facet 48 and the middle finger placement frontal facet 40 may be combined to form a middle finger placement groove.

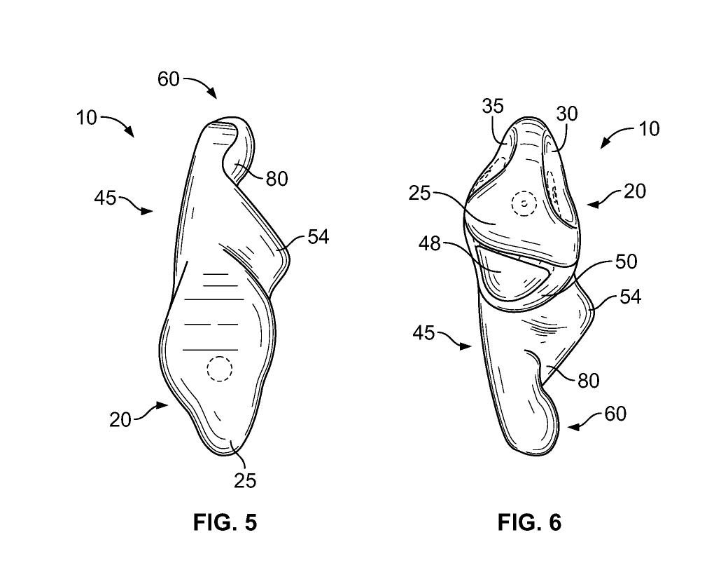

FIG. 5 shows a top view of a preferred embodiment of the current invention. Shown in FIG. 5 is a writing implement including a pen/pencil grip 10 and a pen/pencil 100, wherein the pen/pencil grip 10 comprises a head section 20, a middle section 45, and a tail section 60. The middle section 45 of the pen/pencil grip 10 includes a side bulge 54 and between the middle section 45 and tail section 60 is a thenar placement groove 80.

FIG. 6 shows a bottom view of a preferred embodiment of the current invention. Shown in FIG. 6 is a writing implement including a pen/pencil grip 10 and a pen/pencil 100, wherein the pen/pencil grip 10 comprises a head section 20, a middle section 45, and a tail section 60. The head section 20 includes a head section frontal end 25, a thumb placement recess 30, and an index finger placement recess 35. The middle section 45 of the pen/pencil grip 10 includes a side bulge 54, and a lower bulge 50, wherein the lower bulge 50 includes a middle finger placement back facet 48 positioned adjacent to the middle finger placement frontal facet 40 of the head section 20, so that the middle finger placement back facet 48 and the middle finger placement frontal facet 40 may be combined to form a middle finger placement groove. Between the middle section 45 and tail section 60 is a thenar placement groove 80.

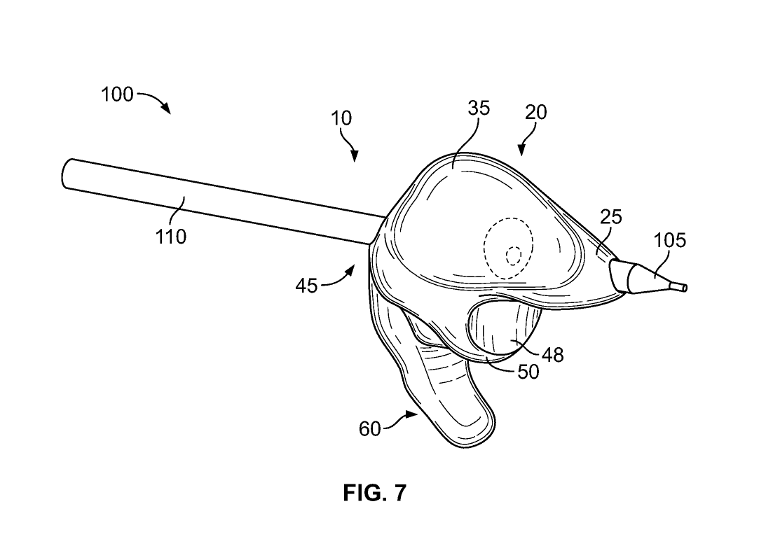

FIG. 7 shows a bottom side perspective view of a preferred embodiment of the current invention. Shown in FIG. 7 is a writing implement including a pen/pencil grip 10 and a pen/pencil 100, wherein the pen/pencil grip 10 comprises a head section 20, a middle section 45, and a tail section 60, and the pen/pencil 100 includes a tip 105 and a shaft 110. The head section 20 includes a head section frontal end 25, and an index finger placement recess 35. A shaft placement channel extends through the head section 20 and the middle section 45 with existing holes on the top of the middle section 45 and the head section frontal end 25. The shaft 110 of the pen/pencil 100 is securely accommodated by the shaft placement channel, wherein the tip 105 extends out of the hole on the head section frontal end 25. The middle section 45 of the pen/pencil grip 10 includes a lower bulge 50 having a middle finger placement back facet 48 positioned adjacent to a middle finger placement frontal facet 40 (not shown in FIG. 7) of the head section 20, so that the middle finger placement back facet 48 and the middle finger placement frontal facet 40 may be combined to form a middle finger placement groove.

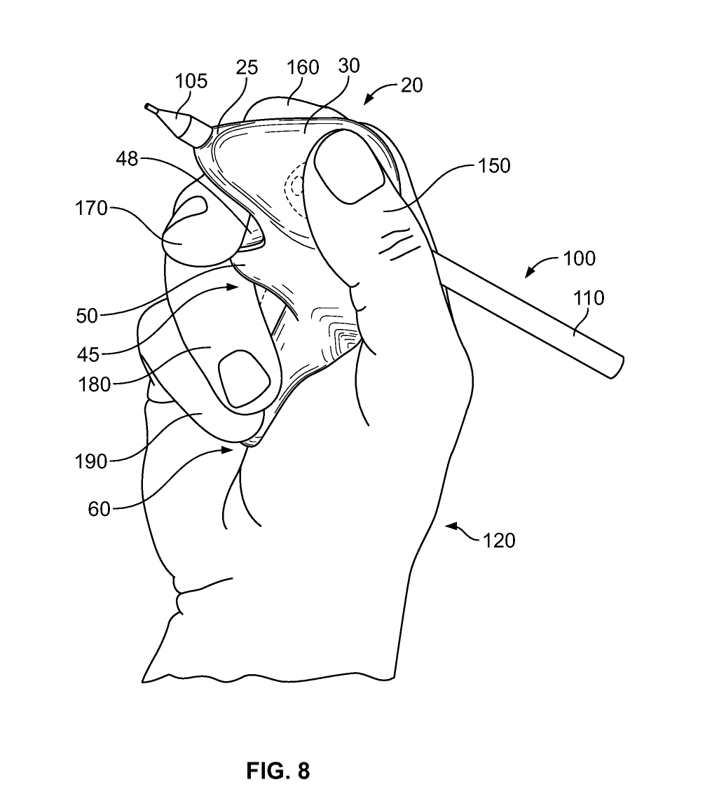

FIG. 8 shows a side perspective view of a preferred embodiment of the current invention wherein the embodiment is use. Shown in FIG. 8 is a writing implement being held by a hand 120, wherein the hand 120 shows a thumb 150, an index finger 160, a middle FIG. 170, a ringer finger 180, and a little finger 190, the writing implement includes a pen/pencil grip 10 and a pen/pencil 100, the pen/pencil grip 10 comprises a head section 20, a middle section 45, and a tail section 60, and the pen/pencil 100 comprises a tip 105 and a shaft 110. The head section 20 includes a head section frontal end 25, a thumb placement recess 30, and an index finger placement recess 35 (not shown in FIG. 8). A shaft placement channel extends through the head section 20 and the middle section 45 with existing holes on the top of the middle section 45 and the head section frontal end 25. The shaft 110 of the pen/pencil 100 is securely accommodated by the shaft placement channel, wherein the tip 105 extends out of the hole on the head section frontal end 25. The middle section 45 of the pen/pencil grip 10 includes a lower bulge 50 having a middle finger placement back facet 48 positioned adjacent to a middle finger placement frontal facet 40 (not shown in FIG. 8) of the head section 20, so that the middle finger placement back facet 48 and the middle finger placement frontal facet 40 may be combined to form a middle finger placement groove. The ring finger 180 and the little finger 190 rest on the tail section 60.

Referring to all the Figures listed above, it is preferable that the head section 20, the middle section 45, and the tail section 60 form a continuous and smoothly connected body. It is possible that these three parts are physically distinctive and easy the separate. However, to provide maximum level of comfort and usability, the three sections of the pen/pencil grip 10 are preferably inseparable and lack distinct boundaries.

Referring to FIGS. 1, 3, 6, and 8, the thumb placement recess 30 may have a shallow alcove contour configured to receive a human thumb 150. More particular, the thumb placement recess 30 is preferably configured to receive a distal phalanx of a human thumb 150, which may be pressed against the thumb placement recess 30.

Referring to FIGS. 1, 3, 6, 7 and 8, the index finger placement recess 35 may have a shallow alcove contour configured to receive a human index finger 160. More particular, the index finger placement recess 35 is preferably configured to receive a distal phalanx of a human thumb 160, which may be pressed against the index finger placement recess 35.

Referring to FIGS. 2-4 and 6-8, the middle finger placement frontal facet 40 and the middle finger placement back facet 48 combine to form a middle finger placement groove for the placement of a human middle finger 170. In particular, the middle finger placement groove is preferably configured to receive a distal phalanx of a human middle finger 170. More precisely, the distal phalanx of the middle finger 170 is preferably pressed against the middle finger placement back facet 48 for secure gripping.

Referring to FIGS. 3 and 8, the ring finger groove 70 may be configured to receive a human ring finger 180. More particularly, the ring finger groove 70 is preferably configured to receive a distal phalanx of a human ring finger 180. Similarly, the little finger groove 75 may be configured to receive a human little finger 190. The little finger groove 75 is preferably configured to receive a distal phalanx of a human little finger 190. The tail section 60 extends from the middle section 45 and is pressed against the palm by the ring finger 180 and the little finger 190, providing further stabilization for the pen/pencil grip 10.

Referring to FIGS. 2, 3, 6 and 8, the middle section 45 may include a side bulge 54 corresponding to a position between the thumb 150 and the index finger 160. Such a structure may make the contact more solid and comfortable for the holder.

Referring to FIGS. 3, 5, 6 and 8, between the middle section 45 and the tail section 60 there may be a thenar placement groove 80 configured to receive the thenar eminence of the human palm. Thenar eminence, or ball of thumb, is the mildly bulging lump of muscle right under the thumb. Having a groove structure for the thenar eminence makes the gripping more comfortable.

Referring to FIGS. 1-4 and 6-8, the thumb placement recess 30, the index finger placement recess 35, the middle finger placement frontal facet 40, and the middle finger placement back facet 48 may all be decorated with markings or inscriptions. In the embodiment shown here, the overall pen/pencil grip 10 is decorated as a little shark, wherein drawings showing eyes are illustrated in the thumb placement recess 30 and the index finger placement recess 35, and drawings showing mouth and teeth are illustrated on the middle finger placement frontal facet 40 and middle finger placement back facet 48. While the exact shape of the pen/pencil grip may vary, the decoration may vary as well.

To ensure full functionality, the current invention may have embodiments that are suitable to either the right hand or the left hand. The embodiment shown in FIGS. 1-8 is suitable for use by the right hand, wherein the side bulge 54 is on the right of the middle section 45 viewed from the middle finger placement back facet 48 (as shown in FIG. 6) and thenar placement groove 80 is on the right of the middle section 45 viewed from the middle finger placement back facet (as shown in FIG. 6). As indicated above, the left hand implement for the current invention may be a mirror image of the right hand implement or alternative there may be small differences between the two implements. For example, the pen/pencil tip 105 may protrude further from the pen/pencil grip 10 for left handed implement than the right handed implement due to the nature of how left handed people must write to avoiding wiping the written words with their hand.

As indicated above, the current invention may also incorporate accessory structures to improve the results for better gripping postures. For example, the pen/pencil grip may include indicators such as LED lights, bulbs, mini-screens, buzzers, heating elements or any other accessories that may be used to display text, images, patterns, light, emit sound, or provide any other kinds of signal. The indicators may be positioned anywhere, but are preferably attached to the pen/pencil grip as places that are visible when the pen/pencil grip is in use. E.g. between the thumb placement recess and the index finger placement recess on top of the head section. Underneath the finger locations, such as but not limited to the thumb placement recess and the index finger placement recess, there may also be electrical switches, such as but not limited to mechanical, capacitive, resistive, or light sensitive switches, so that correctly or incorrectly positioned fingers may be detected. Such detections may trigger or alter the display or emission of the indicators, e.g., making the LED flash, serving as a sign for correct or incorrect gripping of the pen/pencil. To allow the indicator/switch accessories function properly, the pen/pencil grip may also include a power source, such as a battery.

The current invention covers not only the embodiments that include only the pen/pencil grip, but also embodiments comprising the pen/pencil grip combined with a pen/pencil, forming a writing apparatus. The connection between the pen/pencil and the grip may be removable—detachment does not cause physical damage to the components—or permanent—detachment causes physical damage to the components.

The size of the pen/pencil grip may vary to fit different kinds of writing implements and different hand sizes. The overall length measure from the head section frontal end 25 to the end of the tail section 60 is preferably between about 10 mm to about 100 mm. It is also preferably that the pen/pencil grip is small and easily portable.

The pen/pencil grip may be made from any material. While it is preferable that the different sections are made from the same materials, such is not a strict requirement. The pen/pencil grip may be made from materials such as but not limited to: metals such as gold, silver, platinum, titanium, and alloy, glass or fiberglass, rubber, composite materials, and plastic such as, but not limited to, polyethylene terephthalate (PET), high-density polyethylene, polyvinyl chloride (PVC), polyvinylidene chloride (PVDC), polystyrene (PS), high impact polystyrene (HIPS) and polycarbonate (PC), or some combination thereof. It is preferred that the material is robust and durable.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A pen/pencil grip, comprising:
a head section having a head section frontal end flanged by a thumb placement recess, an index finger placement recess, and a middle finger placement frontal facet;
a middle section connected to the head section opposite to the head section front end, the middle section having a lower bulge with a middle finger placement back facet positioned adjacent to the middle finger placement frontal facet;
and a tail section connected to the middle section opposite to the head section, wherein
the head section, the middle section, and the tail section form a continuous and smoothly connected body,
the thumb placement recess has a shallow alcove contour configured to receive a distal phalanx of a human thumb,
the index finger placement recess has a shallow alcove contour configured to receive a distal phalanx of a human index finger,
the middle finger placement front facet and the middle finger placement back facet combines to form a middle finger placement groove configured to allow the placement of a distal phalanx of a human middle finger,
the tail section is an elongated structure extended from the middle section,
the tail section includes a ring finger placement recess configured to receive the distal phalanx of a human ring finger,
the tail section includes a little finger placement recess configured to receive the distal phalanx of a human little finger,
there is a pen/pencil shaft placement channel extending from the head section frontal end through the head section and middle section, and
the pen/pencil shaft placement channel is configured to accommodate a shaft of a pen/pencil.

2. The pen/pencil grip of claim 1, wherein:
the thumb placement recess and the index finger placement recess are decorated with drawings.

3. The pen/pencil grip of claim 1, wherein:
the middle section includes a side bulge corresponding to a position between the thumb and the index finger.

4. The pen/pencil grip of claim 1, wherein
between the tail section and the middle section there is a thenar placement groove configured to receive the thenar eminence of a human hand.

5. The pen/pencil grip of claim 4, wherein:
the middle section includes a side bulge corresponding to a position between the thumb and the index finger.

6. The pen/pencil grip of claim 5, wherein
the pen/pencil grip is suitable for a right hand,
the side bulge is on the right of the middle section viewed from the middle finger placement back facet,
and thenar placement groove is on the right of the middle section viewed from the middle finger placement back facet.

7. The pen/pencil grip of claim 5, wherein
the pen/pencil grip is suitable for a left hand,
the side bulge is on the left of the middle section viewed from the middle finger placement back facet,
and thenar placement groove is on the left of the middle section viewed from the middle finger placement back facet.

8. The pen/pencil grip of claim 1, wherein
the head section, the middle section, and the tail section are made from composite materials.

9. A writing apparatus, comprising:
a pen/pencil grip having:
a head section having a head section frontal end flanged by a thumb placement recess, an index finger placement recess, and a middle finger placement frontal facet;
a middle section connected to the head section opposite to the head section front end, the middle section having a lower bulge with a middle finger placement back facet positioned adjacent to the middle finger placement frontal facet;
and a tail section connected to the middle section opposite to the head section, and a pen having a shaft,
wherein
the head section, the middle section, and the tail section form a continuous and smoothly connected body,
the thumb placement recess has a shallow alcove contour configured to receive a distal phalanx of a human thumb,
the index finger placement recess has a shallow alcove contour configured to receive a distal phalanx of a human index finger,
the middle finger placement front facet and the middle finger placement back facet combines to form a middle finger placement groove configured to allow the placement of a distal phalanx of a human middle finger,
the tail section is an elongated structure extended from the middle section, the tail section includes a ring finger placement recess configured to receive the distal phalanx of a human ring finger,
the tail section includes a little finger placement recess configured to receive the distal phalanx of a human little finger,
there is a shaft placement channel extending from the head section frontal end through the head section and middle section, and
the shaft of the pen is secured within the shaft placement channel.

10. The writing apparatus of claim 9, wherein:
the thumb placement recess, the index finger placement recess, and the middle finger placement groove are decorated with drawings.

11. The writing apparatus of claim 9, wherein:
the middle section includes a side bulge corresponding to a position between the thumb and the index finger.

12. The writing apparatus of claim 9, wherein
between the tail section and the middle section there is a thenar placement groove configured to receive the thenar eminence of a human hand.

13. The writing apparatus of claim 12, wherein:
the middle section includes a side bulge corresponding to a position between the thumb and the index finger.

14. The writing apparatus of claim 13, wherein
the pen/pencil grip is suitable for a right hand, the side bulge is on the right of the middle section viewed from the middle finger placement back facet,
and thenar placement groove is on the right of the middle section viewed from the middle finger placement back facet.

15. The writing apparatus of claim 13, wherein
the pen/pencil grip is suitable for a left hand,
the side bulge is on the left of the middle section viewed from the middle finger placement back facet,
and thenar placement groove is on the left of the middle section viewed from the middle finger placement back facet.

16. The writing apparatus of claim 9, wherein
the head section, the middle section, and the tail section are made from composite materials.
